(19) United States
(12) Patent Application Publication
(10) Pub. No.: US 2026/0339934 A1
(43) Pub. Date: Oct. 29, 2026

(54) DATABASE TRANSLATION USING A DISTRIBUTED PROXY SERVICE

(71) Applicant: eBay Inc., San Jose, CA (US)

(72) Inventors: Timothy David Robison, Orangevale, CA (US); Douglas Wayne Hathaway, El Dorado Hills, CA (US); Li Zhengguan, Allen, TX (US); Ramashri Satish Umale, Campbell, CA (US); Steven Bruce West, Roseville, CA (US)

(73) Assignee: eBay Inc., San Jose, CA (US)

(21) Appl. No.: 19/189,345

(22) Filed: Apr. 25, 2025

(51) Int. Cl. G06F 16/2452; G06F 16/242

(52) U.S. Cl. CPC G06F 16/2452; G06F 16/2433

(57) ABSTRACT

Database translation techniques using a distributed proxy service are described. The distributed proxy service is configurable to employ a translation library supporting a variety of database dialects. The distributed proxy service acts as an intermediary layer between applications and databases, intercepting database requests during transmission before reaching an intended destination. The distributed proxy service parses the database requests and, using the translation library, rewrites the database requests from a first database dialect into a second database dialect having a correct syntax while maintaining semantic meaning.

### BACKGROUND

Databases are structured collections of data implemented using storage devices and organized for efficient storage, retrieval, and management of data. Databases serve as a backbone for numerous computational functionalities implemented across a variety of scenarios that involve storing and processing vast amounts of data. Databases can range from small, localized systems used by individual businesses to massive, distributed systems supporting global operations for multinational corporations.

A service provider system, for instance, may execute thousands of different applications as part of providing digital services that are accessible via a network. Databases are used in support of functionality of these different applications to maintain and control access to data utilized by the applications. Consequently, in conventional techniques changes made in a usage scenario involving a single database (e.g., to migrate from one database type to another) may have introduce a multitude of technical challenges to execution of these thousands of different applications with a corresponding increase of computational resource usage, introduce of operational errors, and potential downtime of digital services that rely on execution of the applications and databases.

### SUMMARY

Database translation techniques using a distributed proxy service are described. The distributed proxy service is configurable to employ a translation library supporting a variety of database dialects. The distributed proxy service acts as an intermediary layer between applications and databases, intercepting database requests during transmission before reaching an intended destination. The distributed proxy service parses the database requests and, using the translation library, rewrites the database requests from a first database dialect into a second database dialect having a correct syntax while maintaining semantic meaning. These techniques enable seamless translation between different database dialects without involving modifications to the applications or the databases themselves. These techniques also enable service provider systems to migrate database systems or support multiple database types simultaneously without extensive application rewrites or downtime, significantly reducing complexity and risk associated with large-scale database migrations.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ database translation techniques as employing a distrusted proxy service as described herein.

FIG. 2 depicts a system in an example implementation showing operation of a distributed proxy service of FIG. 1 in greater detail as generating a dialect translation module for inclusion as part of a translation library.

FIG. 3 is a flow diagram depicting a step-by-step procedure in an example implementation of operations performable by a processing device for accomplishing a result of generation of a dialect translation module that is configured for translation between first and second database dialects.

FIG. 4 depicts a system in an example implementation showing operation of a distributed proxy service of FIG. 1 in greater detail as performing database dialect translation using a dialect translation module from a translation library of FIG. 2.

FIG. 5 is a flow diagram depicting a step-by-step procedure in an example implementation of operations performable by a processing device for accomplishing a result of translation between a first database dialect and a second database dialect using a dialect translation module selected from a translation library.

FIG. 6 depicts a system in an example implementation showing operation of a distributed proxy service of FIG. 1 in greater detail as performing database migration using a translation library of FIG. 2.

FIG. 7 is a flow diagram depicting a step-by-step procedure in an example implementation of operations performable by a processing device for accomplishing a result of database migration from a first database implementing a first database dialect and a second database implementing a second database dialect using a dialect translation module selected from a translation library.

FIG. 8 illustrates an example system including various components of an example device that can be implemented as any type of computing device as described and/or utilize with reference to FIGS. 1-7 to implement embodiments of the techniques described herein.

### DETAILED DESCRIPTION

### Overview

Databases employ storage devices to maintain and manage structured collections of data implemented and organized for efficient storage, retrieval, and management of data. Databases are employed in a variety of usage scenarios. Examples of database uses include e-commerce platforms (e.g., that manage product inventories, customer information, and transaction histories), healthcare systems (e.g., that store patient records, treatment plans, and medical research data), financial institutions (e.g., that handle account information, transactions, and regulatory compliance data), social media platforms (e.g., that manage user profiles, posts, and interaction data), and so forth. Consequently, databases often find operation in scenarios by service provider systems that involve a multitude of computational resources and corresponding technical challenges.

Database migration, for example, presents significant technical challenges, especially for large-scale service provider systems to migrate between different database types. The complexity arises from incompatibility of database dialects (e.g., query languages and syntaxes) across various database systems. For organizations with extensive application ecosystems that operate hundreds of thousands of servers, the task of manually rewriting database queries for each application to match a database dialect of a target database is impractical and fraught with operational risks including failure of computational functionalities that rely on the target database.

This technical challenge is compounded when confronted with the intricacies of coordinating migrations with code deployments, desires to implement extensive testing, and the potential for service disruptions. Conventional migration techniques, for example, typically involve modifying code of the applications and as such are inadequate for a scale and complexity commonly found in real-world scenarios that may include thousands of individual applications. As such, technical challenges and limitations of conventional database migration techniques render the migration of large-scale relational workloads exceeding difficult and sometimes unfeasible, creating a significant barrier to database modernization and optimization efforts.

Accordingly, database translation techniques using a distributed proxy service are described. The distributed proxy service, for instance, is configurable to employ a translation library supporting a variety of database dialects. The distributed proxy service is configurable to act as an intermediary layer between applications and databases to translate database requests and/or database responses, automatically and without user intervention. To do so, the distributed proxy service may intercept database requests during transmission (e.g., “in-flight”) before reaching an intended destination.

The distributed proxy service then parses the database requests and, using the translation library, rewrites the database requests from a first database dialect into a second database dialect having a correct syntax while maintaining their semantic meaning. As a result, the distributed proxy service supports seamless translation between different database dialects, such as Oracle to PostgreSQL or SQL Server to MySQL, without involving modifications to the applications or the databases themselves.

The translation library is designed as extensible and database-agnostic and therefore is capable of handling translations between a variety of database supports a variety of database dialects. The translation library, for instance, is configurable to support complex scripting languages (e.g., PL/SQL and PL/pgSQL), manage differences in data types, function calls, and query structures across different database systems, and so forth.

The distributed proxy service may also leverage the translation library to autodetect source and target database dialects, e.g., based on request payloads, database names, predefined routing rules, and so forth thereby supporting dynamic translation of database request and database responses. The distributed proxy service, in one or more implementations, may take a single query in one database dialect, and break the single query up into multiple database queries and/or steps in code, e.g., in scenarios in which direct translation is not available. In a PL/SQL to PL/pgSQL scenario, for instance, a single anonymous PL/SQL statement in a first database dialect is translated into one or more function or procedure setup statements, and then the final executed query is implemented as a call to one of those procedures or statements.

Alternatively, the distributed proxy service is also configurable to manipulate user provided data or database returned data to match a certain format. For example, a first database dialect may support a method for dropping milliseconds in “Date” and “Timestamp” objects, but a second database dialect may not support this functionality. In response, the distributed proxy service may be used to round or truncate dates and timestamps to seconds for storage and then adjust returned values in a similar manner. Database dialects include general dialects (e.g., MySQL) and also version of a general dialect. The distributed proxy service, for instance, may be used to simplify database dialect upgrades that result in syntax or behavioral differences that normally would involve application rewrite.

In this way, the distributed proxy service enables service provider systems to migrate database systems or support multiple database types simultaneously without involving extensive application rewrites or downtime, thereby significantly reducing complexity and risk associated with large-scale database migrations as found in typical digital service scenarios.

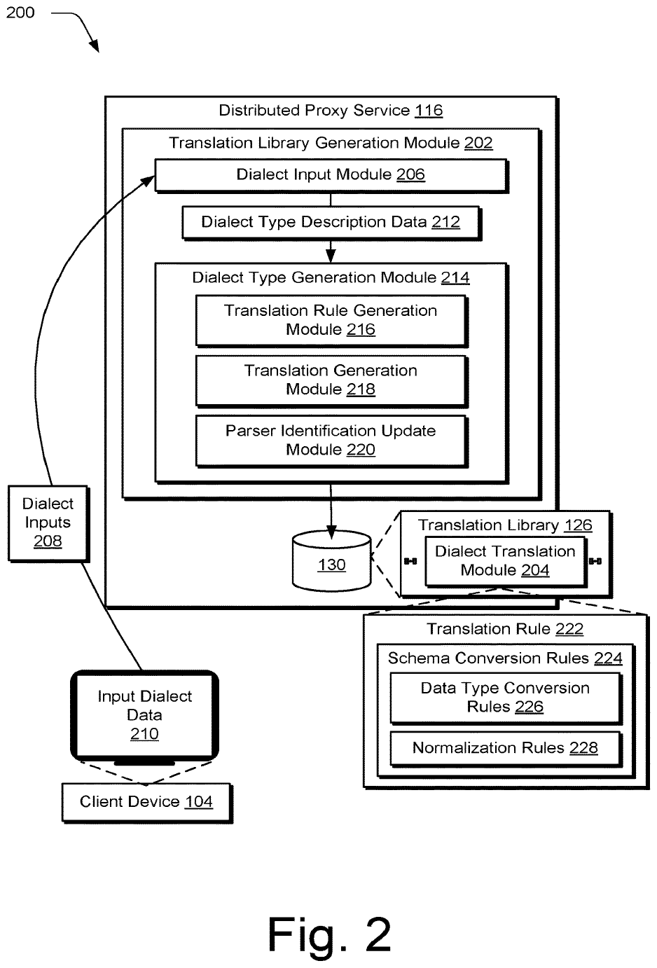

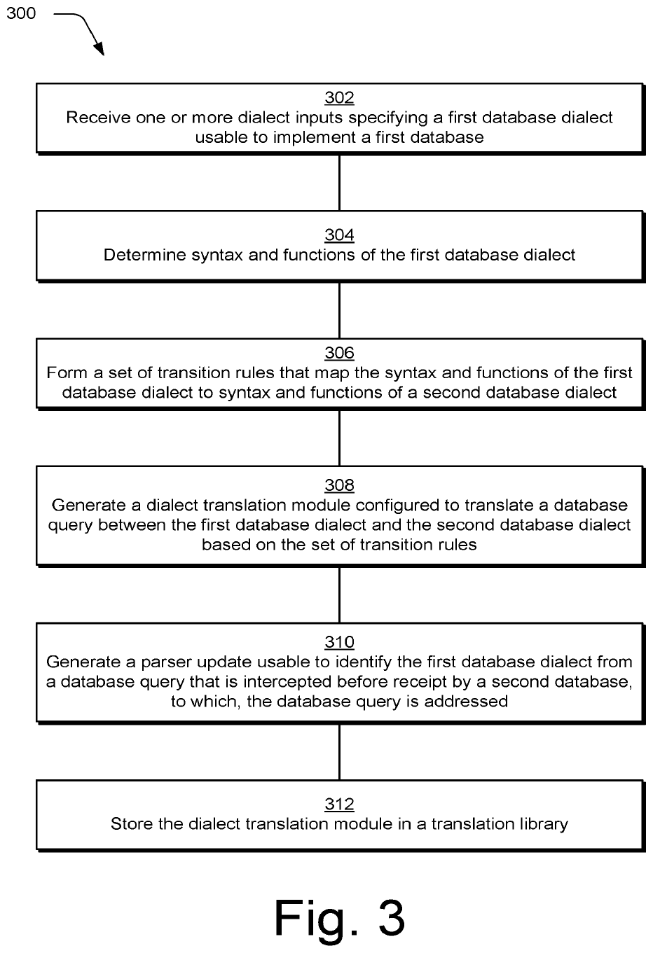

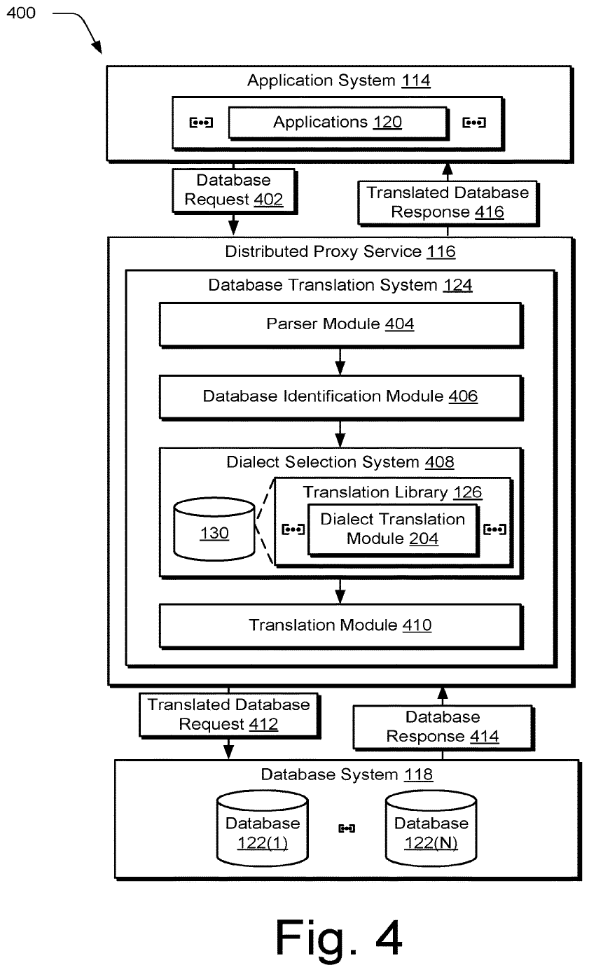

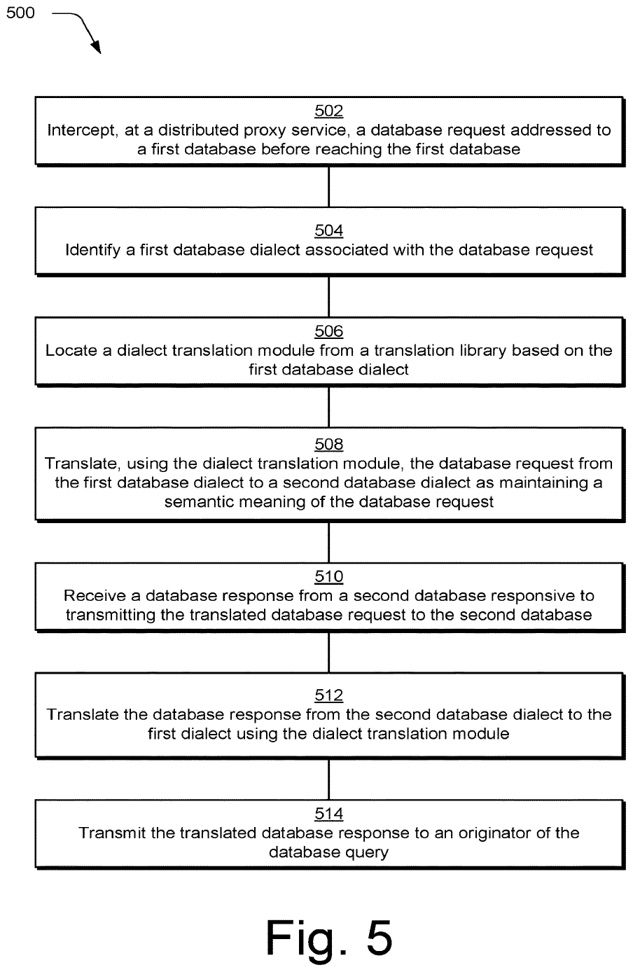

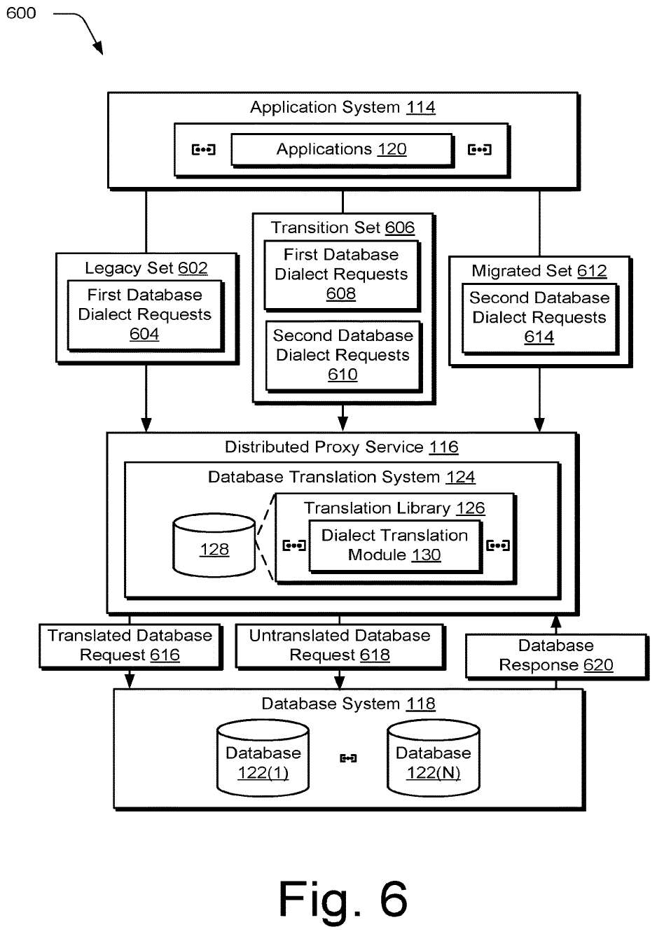

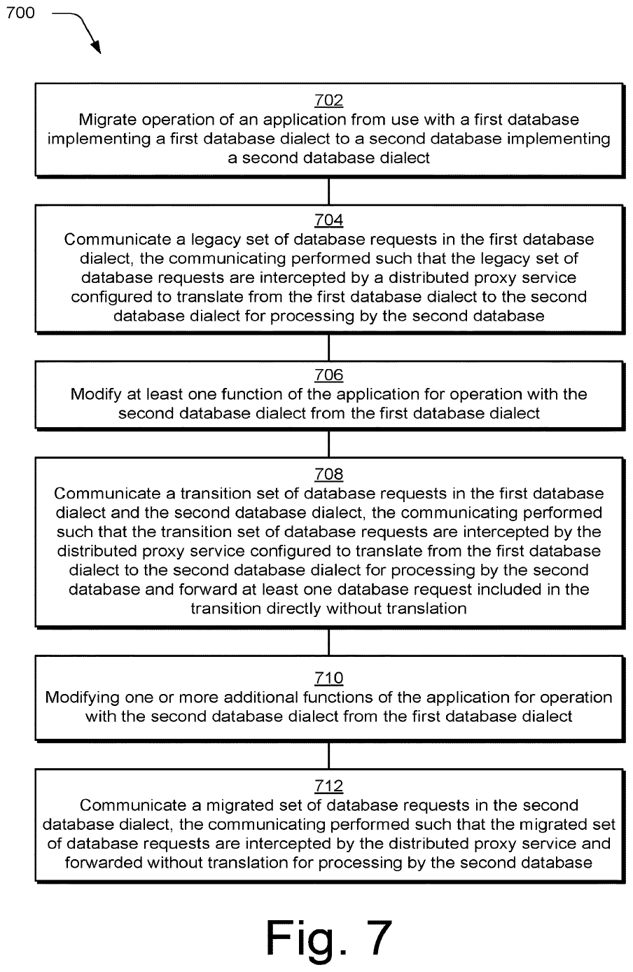

Further discussion of generation of dialect translation modules for inclusion in a translation library of the distributed proxy service may be found in relation to FIGS. 2 and 3. Further discussion of operation of the dialect translation modules in translating database requests and database responses by the distributed proxy service may be found in relation to FIGS. 4 and 5. Further discussion of operation of the dialect translation modules in translating database requests and database responses by the distributed proxy service as part of database migration may be found in relation to FIGS. 6 and 7.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Database Translation Environment

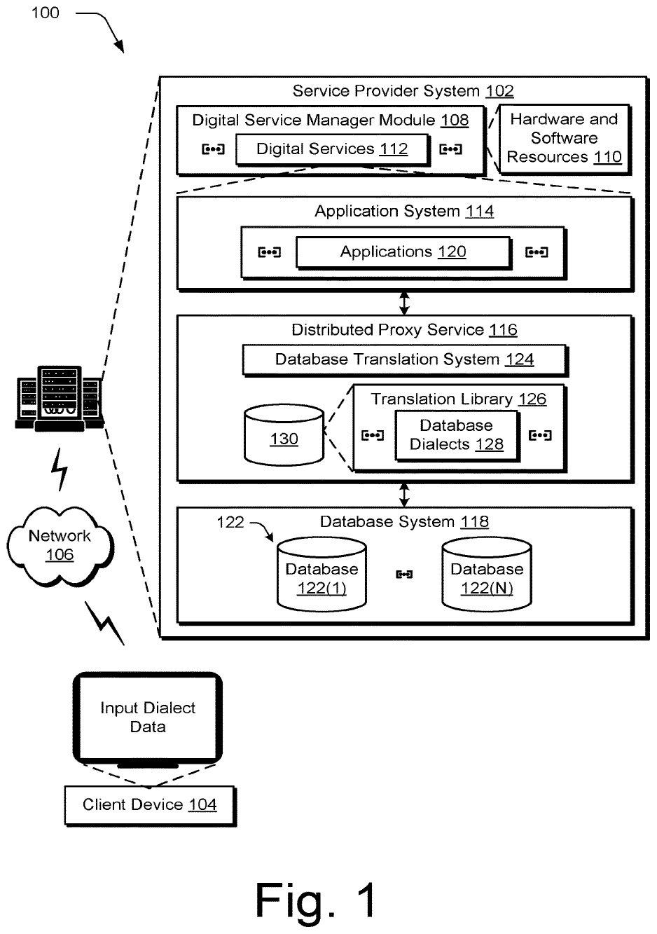

FIG. 1 is an illustration of an environment 100 in an example implementation that is operable to employ database translation techniques as employing a distrusted proxy service as described herein. The illustrated environment 100 includes a service provider system 102 and a client device 104 that are communicatively coupled, one to another, via a network 106. Computing devices that implement the service provider system 102 and client device 104 are configurable in a variety of ways.

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 9.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., the client device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, commerce platforms, and so on.

In the illustrated example, the digital services 112 are utilized to implement an application system 114, a distributed proxy service 116, and a database system 118. The application system 114 is representative of functionality implemented using one or more applications 120 in order to deliver digital services 112 via the network 106. Service provider systems 102 may execute a wide range of applications 120 to deliver digital services 112 accessible via a network. For example, content delivery networks (CDNs) may be implemented by the applications 120 to enable high-performance web services by caching and delivering static resources such as images, videos, and web pages. Applications 120 within a CDN, for instance, are usable to optimize load times and reduce server latency by distributing data across geographically dispersed servers. Similarly, cloud storage platforms support remote storage, retrieval, and management of data, offering functionalities such as file versioning, real-time collaboration, and scalable storage solutions. These services are implemented by applications 120 that integrate file system operations with network protocols like HTTP or FTP for seamless accessibility.

Another example involves online transaction processing (OLTP) systems, which support e-commerce platforms, banking services, and ticket booking systems. In this example, applications 120 manage real-time user transactions by executing processes such as order placement, payment handling, and inventory updates. The applications 120 are executable in this example to ensure data consistency and reliability by leveraging relational databases with ACID properties. Video streaming services, in another example, such as those used for on-demand entertainment or live broadcasts employ applications 120 that execute encoding, transcoding, and adaptive bitrate streaming. These functionalities allow seamless video playback across diverse devices and network conditions.

Additionally, Internet-of-things (IoT) platforms may execute applications 120 to monitor and control connected devices, such as smart thermostats or wearable health monitors. The applications 120 in this example are implemented to handle tasks such as data aggregation, device synchronization, and alert generation while ensuring secure communication via encrypted network protocols. In a further example, virtual desktop infrastructure (VDI) applications enable remote access to virtualized work environments, offering functionalities such as desktop session management, data encryption, and hardware abstraction to ensure high availability and secure connectivity. A variety of other examples are also contemplated.

The database system 118 is illustrated as including a plurality of databases, examples of which are illustrated as database 122(1), . . . , through database 122(N), which may also be referred to collectively or individually as database 122. Database 122(1), for instance, is operable independent of database 122(N). The applications 120, as previously described, are configured to communicate with the databases 122 of the database system 118 to access data used in operation of the applications 120.

Applications 120 within the application system 114, for instance, may generate a variety of database requests that are sent to databases 122 in the database system 118. For example, an e-commerce application may transmit a “SQL SELECT query” to retrieve product information, such as “SELECT product_name, price, inventory FROM products WHERE category=‘electronics’ AND price<500j.” This database request may be directed to database 122(1). Another application 120 may send an “INSERT” statement to add a new user account to another database 122(N), such as “INSERT INTO users (username, email, registration_date) VALUES (‘newuser123’, ‘newuser@example.com’, SY SDATE).”

The databases 122 then generate corresponding database responses to the database requests. For a “SELECT” query, for instance, a database 122 returns a database response having a result set containing rows of product data matching the specified criteria. The database response may be in the form of a tabular dataset with columns for “product_name,” “price,” and “inventory.” For an “INSERT” statement, the database generates a success message indicating a number of rows affected or returns an auto-generated user ID for the new account. In scenarios involving complex stored procedures or functions, the database response may include multiple result sets, output parameters, or status codes indicating the success or failure of various operations. A variety of other examples are also contemplated.

The databases 122 may be configured as having a variety of “types.” Examples of database types include relational databases include “MySQL” and “PostgreSQL” that use structured query language (SQL) for defining and manipulating data, ensuring ACID (atomicity, consistency, isolation, durability) compliance for transaction reliability. “NoSQL” databases (e.g., “MongoDB” and “Cassandra”) offer flexibility in handling unstructured data, providing high scalability and performance for large-scale applications. In-memory databases such as “Redis” and “M emcached” store data in rapid access memory (RAM) for rapid access in support of caching and real-time analytics. Distributed databases are usable to ensure data availability and fault tolerance across multiple nodes, supporting global applications. Each configuration, whether single-node, clustered, or as distributed, addresses specific criteria for data integrity, speed, and scalability.

As previously described, it is increasingly common for service provider systems that provide digital services to employ thousands of applications and databases implemented using tens and even hundreds of thousands of servers. As a result, operability of the applications 120 with the databases 122 encounter numerous technical challenges.

Applications 120, for example, may be written for support of a variety of database dialects. A database dialect is a variant of a query language that is specifically refined for a particular type of database (e.g., database management system) and implemented using computer software that creates, organizes, and maintains databases 122. For example, for an “Oracle” database, “MySQL” and “PostgreSQL” extend a standardized structured query language (SQL) with proprietary features and functions. “MySQL,” for instance, employs a “LIMIT” clause to restrict query results whereas SQL server uses a “TOP” keyword, and Oracle database leverages “ROWNUM” for similar functionality. Such dialect-specific modifications are designed to optimize data storage, retrieval, and processing within each system's unique architecture and often involve use of abstraction layers in frameworks such as object-relational mapping systems to ensure code portability across different platforms.

Support of different database dialects by the applications 120 and the databases 122 encounter numerous technical challenges, one of which involves database migration. As previously described, conventional techniques for database migration face numerous technical challenges, especially in large-scale enterprise environments. For instance, a service provider system may execute thousands of different applications as part of providing digital services that are accessible via a network. These applications rely on databases to maintain and control data access. Consequently, changes to a single database, such as migrating from one database type to another, can introduce a multitude of technical challenges to application execution. These challenges may include increased computational resource usage, introduction of operational errors, and potential downtime of digital services that rely on the execution of these applications and databases.

The complexity is further exacerbated when dealing with incompatible database dialects, query languages, and syntaxes across various database systems. For service provider systems with extensive application ecosystems operating on hundreds of thousands of servers, a task of manually rewriting database queries for each application to match a new database dialect becomes impractical and fraught with operational risks, including potential failure of computational functionalities that rely on the target database.

Accordingly, a distributed proxy service 116 is employed in the illustrated example as an intermediary between the applications 120 of the application system 114 and databases 122 of the database systems 118. The distributed proxy service 116, for instance, is configurable to employ a database translation system 124 and a translation library 126 supporting a variety of database dialects 128, which are illustrated as stored in a storage device 130. The distributed proxy service 116, for instance, is configurable to act as an intermediary layer between applications 120 and the databases 122. To do so, the distributed proxy service 116 may intercept database communications (e.g., database requests which are also referred to as database queries as well as database responses) during transmission (e.g., “in-flight”) before reaching an intended destination. The database translation system 124 is then configured to translate these communications, e.g., from one database dialect to another database dial ect.

Use of a distributed proxy service 116, for instance, during database migration offers significant technical advantages. By acting as an intermediary layer between applications 120 and databases 122, the distributed proxy service 116 supports seamless translation of database queries without involving modifications to the applications or databases themselves. This approach allows migration between different database types and supports multiple database types simultaneously while minimizing disruption to functionalities of the service provider system 102.

The distributed proxy service 116, for example, intercepts database requests during transmission, parses the database requests, and translates the database requests into a compatible database dialect for a target database while maintaining semantic meaning. This dynamic translation capability, supported by an extensible translation library 126, is configurable to handle complex scripting languages and manage differences in data types, function calls, and query structures across various database systems.

As a result, the distributed proxy service 116 significantly reduces complexity, time, and risk associated with large-scale database migrations. The distributed proxy service 116, for instance, enables organizations to modernize a database infrastructure without extensive application rewrites or service downtime, thereby improving efficiencies in operational resource consumption, protection against “down time,” and so forth which is not possible in conventional techniques. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Dialect Translation Module Generation

The following discussion describes dialect translation module generation techniques for a translation library that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 2 depicts a system 200 in an example implementation showing operation of the distributed proxy service 116 of FIG. 1 in greater detail as generating a dialect translation module for inclusion as part of a translation library. FIG. 3 is a flow diagram depicting a step-by-step procedure 300 in an example implementation of operations performable by a processing device for accomplishing a result of generation of a dialect translation module that is configured for translation between first and second database dialects. In the following discussion, reference is made in parallel to FIGS. 2 and 3.

The distributed proxy service 116 in this example implements a translation library generation module 202 to generate a translation library 126, and more particularly a dialect translation module 204 to implement a translation involving a first database dialect. The translation, for instance, may involve a translation to a second database dialect, such as intermediary database dialect that is further translated to a plurality of other database dialects, directly to a database dialect used by a particular database 122, and so forth.

To do so, a dialect input module 206 is employed to receive one or more dialect inputs 208 specifying a first database dialect usable to implement a first database (block 302). The one or more dialect inputs 208 may be input in a variety of ways. In the illustrated example, a user interface 210 is output by a client device 104 to “input dialect data,” e.g., manually. In another example, the user interface 210 includes functionality to obtain a schema associated with the first database dialect, e.g., via upload, hyperlink, and so forth.

In one or more examples, the user interface 210 may be output by a client device 104 to allow manual input of dialect data. In an implementation, a database administrator may use the user interface 210 to manually enter syntax rules for a database dialect, such as specifying that a “SY SDA TE” function is used to obtain a current date and time. Alternatively, the user interface 210 may include functionality to obtain a schema associated with the first database dialect through automated techniques, e.g., the user interface 210 may provide options to upload a database schema file, enter a hyperlink to a schema repository, or connect directly to a sample database to extract schema information.

In another example, the dialect input module 206 may be configured to accept dialect inputs 208 in the form of sample queries or scripts that are representative of the first database dialect. The user interface 210, for instance, may receive a set of typical SQL queries used in a database, such as “SELECT FROM users WHERE last_login >DATE_SUB(NOW( ), INTERVAL 30 DAY)” to demonstrate dialect-specific date manipulation functions. Additionally, the user interface 210 may offer an option that is user selectable to import official documentation or reference manuals for a particular database system, allowing the dialect input module 206 to automatically extract and categorize the data to form dialect type description data 212.

A dialect type generation module 214 is then employed to process the dialect type description data 212 as a basis to generate the dialect translation module 204. To do so, the dialect type generation module 214 employs a translation rule generation module 216, a translation generation module 218, and a parser identification update module 220. The translation rule generation module 216 is configured to determine syntax and functions of the first database dialect (block 304) and form a set of translation rules 222 that map the syntax and functions of the first database dialect to syntax and functions of a second database dialect (block 306). The set of translation rules 222 then serve as a basis by the translation generation module 216 to generate the dialect translation module 204 as configured to translate a database request between the first database dialect and the second database dialect based on the set of translation rules (block 308).

The translation rule generation module 216, in one or more examples, is configurable to determine a syntax and functions of the first database dialect and from this form a set of translation rules 222 that provide a mapping to the syntax and functions of a second database dialect. For example, when translating from a first database dialect to a second database dialect, the translation rule generation module 216 identifies that the first database dialect uses a “SY SDA TE” function to obtain a current date and time, while the second database dialect uses “CURRENT TIMESTAMP.” Accordingly, a translation rule 222 is created by the translation rule generation module 216 to map “SY SDATE” to “CURRENT TIMESTAMP.” Similarly, the translation rule generation module 216 may recognize that a “NVL” function of the first database dialect is equivalent to a “COALESCE” function of a second database dialect and therefore create a translation rule 222 to translate between these functions.

The translation generation module 218 then uses these translation rules 222 as a basis to generate the dialect translation module 204. The translation generation module 218, for instance, generates schema conversion rules 224 includes data type conversion results 226 and normalization rules 228 that are used to implement translation of the first database dialect.

In one such example, the translation generation module 218 creates functions that are executable by the dialect translation module 204 to transform SQL statements from a first database dialect to a second database dialect. For instance, the dialect translation module 204 is configurable to implement a function that replaces each occurrence of “TO_CHAR (SYSDATE, ‘YYYY-MM-DD’)” in a first database dialect with “TO CHAR(CURRENT TIMESTAMP, ‘YYYY-MM-DD’)” in accordance with a second database dialect. The translation generation module 218 may also address complex translations, such as converting a hierarchical query syntax using “CONNECT BY” to recursive common table expressions (CTEs). A variety of other examples are also contemplated.

The dialect type generation module 214 is also configurable to employ the parser identification update module 220 to generate a parser update usable to identify the first database dialect from a database request that is intercepted before receipt by a second database, to which, the database request is addressed (block 310). The parser identification update module 220, for instance, may then update a parser module 404 of the distributed proxy service 116 to recognize specific syntax elements of the first database dialect, enabling accurate identification and subsequent translation of incoming queries.

A parser module 404, for instance, is employed by the distributed proxy service 116 to identify a particular dialect from a database request and/or database response. To do so, for instance, the parser identification update module 220 may update the parser module 404 of the distributed proxy service 116 to recognize specific syntax elements, e.g., use of “DUAL” in queries like “SELECT SY SDATE FROM DUAL.” In this way, the parser update enables the parser module 404 to distinguish database queries in the first database dialect from other database dialects, e.g., which may use “SELECT NOW( )” for a similar operation. These updates allow the distributed proxy service 116 to accurately identify a database dialect of incoming database requests (e.g., queries), even in complex scenarios where multiple database types are in use simultaneously.

This process may be repeated to store a plurality of dialect translation modules 204 (block 312) as part of the translation library 126. Through the modular nature of the translation library 126, the distributed proxy service 116 may efficiently respond to database changes, implement migrations, and so forth in a manner this is not possible using conventional techniques. Further discussion of operation of the database translation modules 204 may be found in relation to the following section and shown in corresponding figures.

### Example Dialect Translation Module Operation

The following discussion describes an example of dialect translation module operation that is implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 4 depicts a system 400 in an example implementation showing operation of the distributed proxy service 116 of FIG. 1 in greater detail as performing database dialect translation using a dialect translation module from a translation library of FIG. 2. FIG. 5 is a flow diagram depicting a step-by-step procedure 500 in an example implementation of operations performable by a processing device for accomplishing a result of translation between a first database dialect and a second database dialect using a dialect translation module selected from a translation library. In the following discussion, reference is made in parallel to FIGS. 4 and 5.

To begin in this example, a distributed proxy service 116 intercepts a database request addressed to a first database before reaching the first database (block 502). The application 120 of the application system 114, for instance, may address database requests for receipt by a first database. However, the distributed proxy service 116, acting as an intermediary, intercepts the database requests 402 before reaching the database system 118. For example, an e-commerce application may transmit a SQL query of “SELECT product_name, price FROM products WHERE category=‘electronics’ AND price<500” which is intended for a first database implemented using a first database dialect.

A first database dialect is identified that is associated with the database request (block 504) by a parser module 404. The parser module 404 is configured to identify the first database dialect based on syntax, structure, content, or the address to which the database request 402 is sent. For example, the parser module 404 may recognize dialect-specific syntax such as the use of “SY SDATE” or “NVL” functions, indicating that the database request 402 is in a particular database dialect.

A database identification module 406 may also be employed to identify a second database, to which, the database request 402 is to be rerouted. This functionality operates transparently, such that the applications 120 are unaware and uninformed that a second database implementing a second database dialect is used to process the database request 402 instead of the first database using the first database dialect. For instance, the database identification module 406 may determine that a database request 402 is to be redirected as part of a migration strategy.

A dialect translation module 204 is then located from a translation library 126 by a dialect selection system 408 based on the first database dialect (block 506) as detected by the parser module 404. The database request 402 is then translated by a translation module 410 using the selected dialect translation module 204 from the first database dialect to a second database dialect while maintaining the semantic meaning of the database request 402 (block 508). The translation module 410, using the selected dialect translation module 204, for instance may transform an Oracle SQL query into PostgreSQL syntax, e.g., by changing “NVL (column_name, 0)” to “COALESCE(column_name, 0),” adjust date functions to match PostgreSQL equivalents, and so forth.

A translated database request 412 compatible with the second database dialect is transmitted to the database system 118, specifically to the second database, e.g., “PostgreSQL” in this example. A database response 414 is received from the second database (block 510) by the translation module 410 after processing of the translated database request 412. This database response 414 may include the requested product data, e.g., in a PostgreSQL-specific format.

The database response 414 is then translated from the second database dialect back to the first dialect using the dialect translation module 204 (block 512). The translation module 410, for instance, may employ the dialect translation module 204 to reformat date outputs, adjust data types to match what the first database would have returned, and so forth. The translated database response 416 is transmitted to the originator of the database request 402 (block 514), e.g., the application 120. In this way, the application receives the translated database response 416 which is compatible, as expected, with the first database dialect. In this way, operation of the distributed proxy service may be performed “behind the scenes” such that the application 120 is unaware of the translation, which database serviced the database request 402, and so forth.

In one or more implementation, the dialect translation module 204 is configured to implement a flag that, when set, indicates that the dialect translation module 204 is to remain queued for operation after generating a translated database request 412. This functionality allows the dialect translation module 204 to be readily available to translate the subsequent database response 414 received from the second database back into the first database dialect. For example, when translating an Oracle SQL query to PostgreSQL, the dialect translation module 204 may set a “waitForResponse” flag to true after generating the translated database request 412.

When this flag is set, the distributed proxy service 116 maintains the dialect translation module 204 in an active state, preserving its context and translation rules. Upon receiving the database response 414 from the second database (e.g., the PostgreSQL database), the translation module 410 may immediately invoke the queued dialect translation module 204 to generate the translated database response 416. This approach ensures that the database response 414 is translated using a same context and rules as the original database request 402, maintaining consistency in the translation process. For instance, if the original database request 402 used a custom function of a first database dialect that was mapped to an equivalent of the second database dialect, the queued dialect translation module 204 retains this mapping to correctly translate references to this function in the response back to the first database dialect. As a result, this technique is usable to enhance translation efficiency and ensure accurate round-trip translation of both data requests and database responses.

### Example Database Migration

The following discussion describes an example of database migration that is are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 6 depicts a system 600 in an example implementation showing operation of the distributed proxy service 116 of FIG. 1 in greater detail as performing database migration using a translation library of FIG. 2. FIG. 7 is a flow diagram depicting a step-by-step procedure 700 in an example implementation of operations performable by a processing device for accomplishing a result of database migration from a first database implementing a first database dialect and a second database implementing a second database dialect using a dialect translation module selected from a translation library. In the following discussion, reference is made in parallel to FIGS. 6 and 7.

As previously described, database migration presents significant technical challenges, especially for large-scale service provider systems transitioning between different types of relational databases. The complexity arises from incompatibility of database dialects (e.g., query languages and syntaxes) across various databases. For organizations with extensive application ecosystems that operate hundreds of thousands of servers, for instance, a task of manually rewriting database requests for each application to match a database dialect of a target database is impractical and fraught with operational risks including failure of computational functionalities that rely on the target database. This technical challenge is compounded when confronted with the intricacies of coordinating migrations with code deployments, desires to implement extensive testing, and the potential for service disruptions.

Database migration typically involves moving data from one database to another, often of a different type or version. This process may include transferring schema structures, data, and sometimes application code to ensure compatibility with a new database, and more particularly an underlying database dialect used by the database. Organizations may undertake database migrations for various reasons, such as upgrading to a modern or scalable database system, reducing licensing costs, improving performance, consolidating data from multiple sources, and so forth. For example, a scenario may involve migrating from a relational database to a cloud-based solution to improve scalability and reduce infrastructure management overhead.

Accordingly, in this example the distributed proxy service 116 smooths database migration by supporting a phased approach from a legacy set 602 of first database dialect requests 604 to a migrated set 612 of second database dialect requests 614. This process begins with the legacy set 602, where each database requests are in the first database dialect as represented as first database dialect requests 604. For example, an e-commerce platform may initially use a first database dialect and therefore database request are written according to that dialect. The distributed proxy service 116 intercepts these legacy requests in the legacy set 602, translates the first database dialect requests 604 to a second database dialect (e.g., PostgreSQL), and forwards the translated database request 616 to the new database system. The database responses 620 are then translated back to the first database dialect at this point in time in the migration before being returned to the application 120, ensuring uninterrupted operation during the initial migration phase.

As the migration progresses, the applications 120 and distributed proxy service 116 enters a transition phase represented by a transition set 606. During this phase, the application 120 begins to incorporate queries written in the second database dialect alongside existing queries in the first dialect, illustrated as first database dialect requests 608 and second database dialect requests 610, respectively. The distributed proxy service 116 is compatible with this mixed environment through use of the dialect translation module 204.

The distributed proxy service 116, for instance, continues to translate the first database dialect requests 608 to generate translated database requests 616 as before, while allowing the second database dialect requests 610 to pass through without translation as untranslated database requests 618. This flexibility supports a gradual update of different parts of the application 120, reducing the risk and complexity associated with a conventional “all-or-nothing” migration technique.

As the migration nears completion in this example, the applications 120 and distributed proxy service 116 moves towards the migrated set 612, where each of the requests are in the second database dialect as represented by second database dialect requests 614. At this stage, the second database dialect requests 614 are written as compatible with the second database dialect and pass through the distributed proxy service 116 without being translated.

The distributed proxy service 116 may remain in place in one or more examples to handle remaining legacy queries that have not been updated, providing a safety net as the migration concludes. Once the application 120 has been successfully updated to use the second database dialect, the translation functionality may be gradually phased out. Throughout this process, the distributed proxy service 116 enables a flexible, low-risk migration strategy that minimizes disruption to ongoing operations and allows for incremental updates to the application codebase.

In one or more examples, operation of an application 120 is migrated from use with a first database 122 implementing a first database dialect to a second database 122 implementing a second database dialect (block 702). For example, this may involve transitioning an e-commerce application from an Oracle database to a PostgreSQL database.

A legacy set 602 of database requests 604 in the first database dialect is communicated (block 704). These requests are intercepted by the distributed proxy service 116, which is configured to translate from the first database dialect (e.g., Oracle SQL) to the second database dial ect (e.g., PostgreSQL) for processing by the second database 122. For instance, an Oracle query such as “SELECT FROM users WHERE SY SDATE-last\_login<30″ would be intercepted and translated.”

At least one function of the application 120 is modified to operate with the second database dialect instead of the first database dialect (block 706). As a result of this modification, the communication of the transition set 606 includes at least one database request 610 in the second database dialect. For example, a user registration function may be updated to use PostgreSQL's “CURRENT\TIMESTAMP” instead of Oracle's “SY SDATE”.

A transition set 606 of database requests, including both first database dialect requests 608 and second database dialect requests 610, is communicated (block 708). The distributed proxy service 116 intercepts these requests, translating those in the first database dialect to the second database dialect for processing by the second database 122, while forwarding requests already in the second database dialect directly without translation.

One or more additional functions of the application 120 are modified to operate with the second database dialect instead of the first database dialect (block 710). Consequently, the communication of the migrated set 612 includes multiple database requests 614 in the second database dial ect.

A migrated set 612 of database requests 614 configured solely in accordance with in the second database dialect is communicated (block 712). These requests are intercepted by the distributed proxy service 116 and forwarded without translation for processing by the second database 122, completing the migration process in this example. A variety of other examples are also contemplated.

### Example System and Device

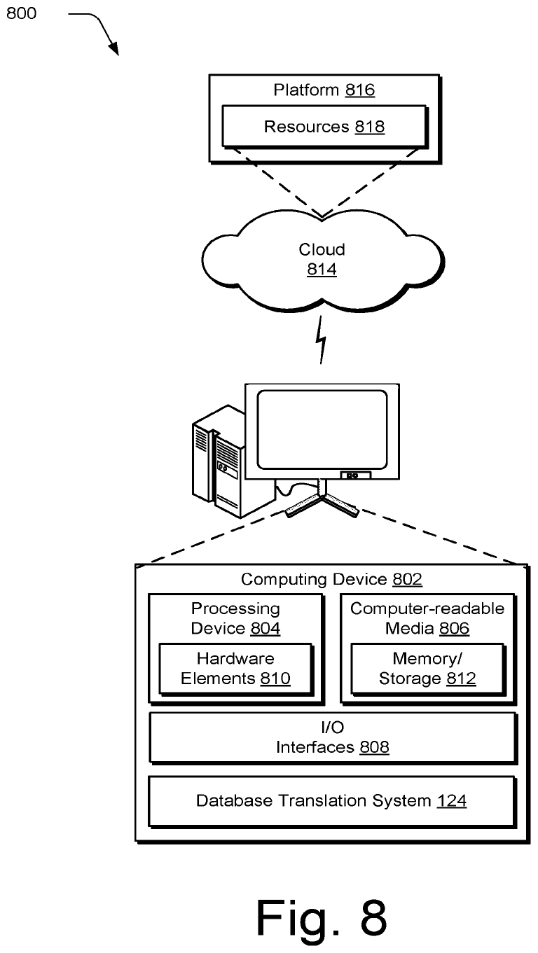

FIG. 8 illustrates an example system generally at 800 that includes an example computing device 802 that is representative of one or more computing systems and/or devices that implement the various techniques described herein. This is illustrated through inclusion of the database translation system 124. The computing device 802 is configurable, for example, as a server of a service provider, a device associated with a client (e.g., a client device), an on-chip system, and/or any other suitable computing device or computing system.

The example computing device 802 as illustrated includes a processing device 804, one or more computer-readable media 806, and one or more I/O interface 808 that are communicatively coupled, one to another. Although not shown, the computing device 802 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 804 is representative of functionality to perform one or more operations using hardware. Accordingly, the processing device 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 806 is illustrated as including memory/storage 812 that stores instructions that are executable to cause the processing device 804 to perform operations. The computer-readable storage medium is configured for storing instructions that, responsive to execution by the processing device, causes the processing device to perform operations. The memory/storage 812 represents memory/storage capacity associated with one or more computer-readable media. The memory/storage 812 includes volatile media (such as random access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA) , a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing device 804. The instructions and/or functions are executable/operable by one or more articles of manufacture (for example, one or more computing devices 802 and/or processing devices 804) to implement techniques, modules, and examples described herein.

The techniques described herein are supported by various configurations of the computing device 802 and are not limited to the specific examples of the techniques described herein. This functionality is also implementable all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized while computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

In implementations, the platform 816 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
intercepting, at a distributed proxy service, a database request addressed to a first database, during transmission of the database request before the database request reaches the first database;
identifying a first database dialect associated with the database request;
locating a dialect translation module from a translation library based on the first database dialect;
automatically translating, using the dialect translation module and independent of user intervention, the database request from the first database dialect to a second database dialect associated with a second database, while maintaining a semantic meaning of the database request;
transmitting the translated database request to the second database;
receiving a database response from the second database in response to processing of the translated database request by the second database;
translating the database response from the second database dialect to the first database dialect using the dialect translation module; and
transmitting the translated database response to an originator of the database request without indicating to the originator that the second database is used to generate the database response instead of the first database.

2. The method as described in claim 1, wherein identifying the first database dialect is based on a request payload of the database request, database name included in the database request, or a routing rule.

3. The method as described in claim 1, wherein the dialect translation module is configured to map syntax and functions of the first database dialect to syntax and functions of the second database dialect.

4. (canceled)

5. (canceled)

6. The method as described in claim 1, wherein syntax and functions of the first database dialect are determined from a first schema defined for the first database dialect and syntax and functions of the second database dialect are determined from a second schema defined for the second database dialect.

7. The method as described in claim 1, further comprising parsing the database request including determining a structure and components of the database request and wherein identifying the first database dialect is performed based on the structure and components of the database request.

8. The method as described in claim 1, further comprising identifying the second database that is to receive the database request based on the database request, wherein the second database is operable independent of the first database.

9. The method as described in claim 1, wherein the first and second database dialects are relational database dialects.

10. A system comprising:
a processing device, and
a computer-readable storage medium storing instructions that, responsive to execution by the processing device, causes the processing device to perform operations including:
receiving one or more dialect inputs specifying a first database dialect usable to implement a first database;
determining syntax and functions of the first database dialect;
forming a set of translation rules that map the syntax and functions of the first database dialect to syntax and functions of a second database dialect;
generating a dialect translation module configured to translate a database request between the first database dialect and the second database dialect based on the set of translation rules;
generating a parser update usable to identify the first database dialect from a database request that is intercepted during transmission before receipt by a second database, wherein the database request is addressed to the second database; and
storing the dialect translation module in a translation library.

11. The system as described in claim 10, further comprising receiving an input specifying a second database and determining the second database dialect as associated with the second database based on a schema associated with the second database.

12. (canceled)

13. The system as described in claim 10, wherein the second database dialect is a representation that is configured for further translation before use with another database having a third database dialect.

14. The system as described in claim 10, further comprising:
intercepting a database request addressed to a second database before reaching the second database;
identifying the second database dialect associated with the intercepted database request;
identifying the first database based on the intercepted database request and the first database dialect associated with the first database;
locating the dialect translation module from the translation library based on the first database dialect and the second database dialect; and
translating, using the dialect translation module, the intercepted database request from the second database dialect to the first database dialect while maintaining a semantic meaning of the intercepted database request.

15. The system as described in claim 14, further comprising:
receiving a database response from the first database responsive to transmitting the translated database request to the first database;
translating the database response from the first database dialect to the second database dialect using the dialect translation module; and
transmitting the translated response to an originator of the intercepted database request.

16. A method comprising:
migrating operation of an application from use with a first database implementing a first database dialect to a second database implementing a second database dialect, the migrating including:
communicating a legacy set of database requests in the first database dialect, the communicating performed such that the legacy set of database requests are intercepted by a distributed proxy service configured to translate from the first database dialect to the second database dialect for processing by the second database;
modifying at least one function of the application for operation with the second database dialect from the first database dialect;
communicating a transition set of database requests including at least one database request in the first database dialect and at least one database request in the second database dialect as a result of modifying the at least one function, the communicating performed such that the transition set of database requests are intercepted by the distributed proxy service configured to translate from the first database dialect to the second database dialect for processing by the second database and forward the at least one database request in the second database dialect included in the transition set of database requests directly without translation; and
communicating a migrated set of database requests in the second database dialect, the communicating performed such that the migrated set of database requests are intercepted by the distributed proxy service and forwarded without translation for processing by the second database.

17. (canceled)

18. The method as described in claim 16, further comprising modifying one or more additional functions of the application for operation with the second database dialect from the first database dialect and wherein communicating the migrated set includes one or more database requests in the second database dialect as a result of modifying the one or more additional functions.

19. The method as described in claim 16, wherein the distributed proxy service is configured to identify the first database dialect, obtain a dialect translation module based on the first database dialect, and perform a translation.

20. The method as described in claim 16, wherein the distributed proxy service is configured as an intermediary between the application and the first and second databases.

21. The method as described in claim 1, wherein the dialect translation module implements a flag that indicates whether the dialect translation module is to remain queued for operation after generating the translated database request.

22. The method as described in claim 21, wherein the flag causes the distributed proxy service to maintain the dialect translation module in an active state preserving context and translation rules of the dialect translation module, and wherein the translating the database response comprises invoking the queued dialect translation module to translate the database response using the preserved context and translation rules.

23. The method as described in claim 1, wherein the translating the database request comprises translating a single database request in the first database dialect into a plurality of database queries in the second database dialect, the plurality of database queries including one or more setup statements and a final executed query implemented as a call to one of the one or more setup statements.

24. The system as described in claim 10, wherein the generating the dialect translation module comprises generating schema conversion rules including data type conversion results and normalization rules that are used to implement translation of the first database dialect.
